(19) United States
(12) Patent Application Publication
(10) Pub. No.: US 2014/0328567 A1
(43) Pub. Date: Nov. 6, 2014

(54) WAVEGUIDE FEEDTHROUGH FOR BROADBAND ELECTROMAGNETIC WAVE ATTENUATION

(71) Applicant: ELECTRONICS AND TELECOMMUNICATIONS RESEARCH INSTITUTE, Daejeon (KR)

(72) Inventors: Uijung KIM, Daejeon (KR); Kwang-Uk CHU, Daejeon (KR); Minseok YOON, Daejeon (KR)

(73) Assignee: ELECTRONICS AND TELECOMMUNICATIONS RESEARCH INSTITUTE, Daejeon (KR)

(21) Appl. No.: 14/262,351

(22) Filed: Apr. 25, 2014

(30) Foreign Application Priority Data
May 3, 2013 (KR) 10-2013-0050062
Dec. 11, 2013 (KR) 10-2013-0153715

(51) Int. Cl. G02B 6/44

(52) U.S. Cl. CPC G02B 6/4429
USPC 385/140

(57) ABSTRACT

A waveguide feedthrough for broadband electromagnetic wave attenuation is provided in an electromagnetic wave shielding structure, in which data processing and communication devices are installed, so that a plurality of optical cables or the like which are connected to data processing and communication devices are led into the electromagnetic wave shielding structure through the waveguide feedthrough. Thereby, broadband electromagnetic waves generated from external other devices can be prevented from entering the electromagnetic wave shielding structure. For this, the waveguide feedthrough includes a waveguide feedthrough body which is made of conductive material and has a through hole therein, and an electromagnetic wave absorber which is provided on an inner side surface of the through hole.

### CROSS REFERENCE TO RELATED APPLICATIONS

This application claims the benefit of Korean Patent Application No. 10-2013-0050062, filed May 3, 2013, and No. 10-2013-0153715, filed Dec. 11, 2013, which is hereby incorporated by reference in its entirety into this application.

### BACKGROUND OF THE INVENTION

1. Technical Field

The present invention relates generally to waveguide feedthroughs and, more particularly, to a waveguide feedthrough which is provided in an electromagnetic wave shielding structure, in which data processing and communication devices are installed, so that a plurality of optical cables or the like which are connected to the data processing and communication devices are led into the electromagnetic wave shielding structure through the waveguide feedthrough, whereby broadband electromagnetic waves generated from external other devices can be prevented from entering the electromagnetic wave shielding structure.

2. Description of the Related Art

Waveguide feedthroughs are essential devices to connect communication wires to data processing/communication devices that are installed in an electromagnetic wave shielding structure or container. Such a waveguide feedthrough has a cylindrical conductive pipe structure which is open on opposite ends thereof. The waveguide feedthrough is installed in such a way that it communicates the interior and exterior of the electromagnetic wave shielding container with each other and is used for connection of communication wires (optical cables) between devices.

Generally, waveguides are transmission lines which are mainly used to transmit electromagnetic waves over a microwave band. The waveguides can transmit only a frequency component greater than a cut-off frequency that is determined by the size of an opening of the waveguide. Compared to coaxial cables or microstrip lines which are transmission lines that partially use dielectric material, the waveguides are advantageous in that because air is used as a medium, dielectric loss is reduced, and the power capacity is increased. Electromagnetic waves that enter the waveguide go forwards by multiple reflections on the inner surface of the waveguide. Therefore, the transmission speed (group speed) of electromagnetic waves in the waveguide is less than the travel speed thereof in free space.

Waveguide feedthroughs are used for installation of communication lines (mainly, optical cables) that connect internal/external devices of electromagnetic wave shielding containers to each other. Unlike the purposes of the typical waveguides, waveguide feedthroughs attenuate (or block) electromagnetic waves. For the sake of production and installation, waveguide feedthroughs generally have a cylindrical shape. Such a waveguide feedthrough is also called a WBC (waveguide below cut-off), because it is used below cut-off frequency. The waveguide feedthrough is typically configured such that the length thereof is four or five times as long as the diameter of a through hole formed in the waveguide feedthrough.

A preceding art that pertains to the above description was proposed in Korean Patent Laid-open Publication No. 2012-0115697, entitled ‘Waveguide and method of manufacturing the waveguide’ (Publication date: Oct. 19, 2012).

### SUMMARY OF THE INVENTION

Accordingly, the present invention has been made keeping in mind the above problems occurring in the prior art, and an object of the present invention is to provide a waveguide feedthrough for broadband electromagnetic wave attenuation which is provided for connection of optical cables in an electromagnetic wave shielding structure, in which data processing and communication devices are installed, and which is configured such that a plurality of optical cables can be led into the electromagnetic wave shielding structure only using a single waveguide feedthrough.

In order to accomplish the above object, the present invention provides a waveguide feedthrough for broadband electromagnetic wave attenuation, including: a waveguide feedthrough body made of conductive material, with a through hole formed in the waveguide feedthrough body; and an electromagnetic wave absorber provided on an inner side surface of the through hole.

The waveguide feedthrough body may have a cylindrical pipe shape.

The electromagnetic wave absorber may have a sheet shape and be attached to the inner side surface of the through hole.

The waveguide feedthrough may be installed in an electromagnetic wave shielding structure, wherein a plurality of optical cables may be led out of the electromagnetic wave shielding structure through the waveguide feedthrough.

In the present invention, a waveguide feedthrough which is used in an electromagnetic wave shielding structure for blocking broadband electronic waves can be manufactured to have a larger diameter than a conventional waveguide feedthrough, thus making it possible to install a plurality of optical cables in a single waveguide feedthrough. Therefore, the electromagnetic wave shielding structure can be designed to have a comparatively simple structure, whereby the production cost can be reduced.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are views showing a conventional waveguide feedthrough;

FIG. 2 is a perspective view illustrating a waveguide feedthrough according to an embodiment of the present invention;

FIG. 3 is a sectional view taken along line A-A of FIG. 2;

FIG. 4 is a sectional view taken along line B-B of FIG. 2;

FIG. 5 is a view illustrating an electromagnetic wave absorber for electromagnetic wave attenuation according to the present invention;

FIG. 6 is a graph showing an electromagnetic wave attenuation capacity as a function of the diameter of a waveguide feedthrough provided without an electromagnetic wave absorber;

FIG. 7 is a graph showing an electromagnetic wave attenuation capacity as a function of the length of a waveguide feedthrough provided without an electromagnetic wave absorber;

FIG. 8 is a graph showing an electromagnetic wave attenuation capacity as a function of the diameter of a waveguide feedthrough provided with an electromagnetic wave absorber;

FIG. 9 is a block diagram showing a test for measuring the electromagnetic wave attenuation capacity of the waveguide feedthrough according to the present invention; and

FIG. 10 is a graph comparing the electromagnetic wave attenuation capacity of the waveguide feedthrough provided with the electromagnetic wave absorber according to the present invention with that of the waveguide feedthrough provided without an electromagnetic wave absorber.

### DESCRIPTION OF THE PREFERRED EMBODIMENTS

Hereinafter, the present invention will be described with reference to the attached drawings.

If in the specification, detailed descriptions of well-known functions or configurations would unnecessarily obfuscate the gist of the present invention, the detailed descriptions will be omitted.

Furthermore, the embodiment of the present invention aims to help those with ordinary knowledge in this art more clearly understand the present invention.

The shape, size, etc. of each element may be exaggeratedly expressed in the drawings for the sake of understanding the present invention.

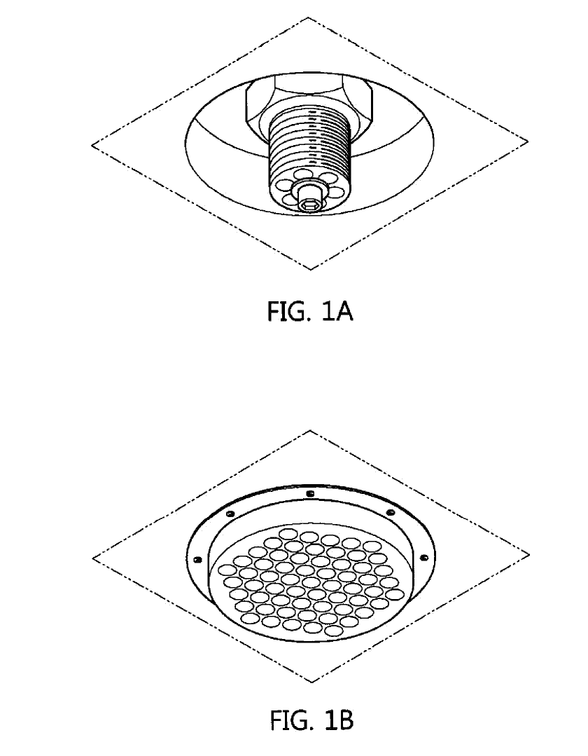

The present invention relates to a waveguide feedthrough which is provided in an electromagnetic wave shielding structure that has therein a receiving space in which data processing and communication devices are installed. Generally, to connect the data processing and communication devices to external devices of the electromagnetic wave shielding structure, a plurality of optical cables are led into the electromagnetic wave shielding structure. A plurality of waveguide feedthroughs each of which has an appropriate diameter to pass a single optical cable is required to prevent external electromagnetic waves from entering the electromagnetic wave shielding structure. FIG. 1 is a view showing the above-described conventional waveguide feedthrough.

The present invention provides a waveguide feedthrough which is configured such that a plurality of optical cables can be led into an electromagnetic wave shielding structure through the single waveguide feedthrough, and which has an improved electromagnetic wave attenuation capacity so that entrance of electromagnetic waves into the electromagnetic wave shielding structure can be minimized.

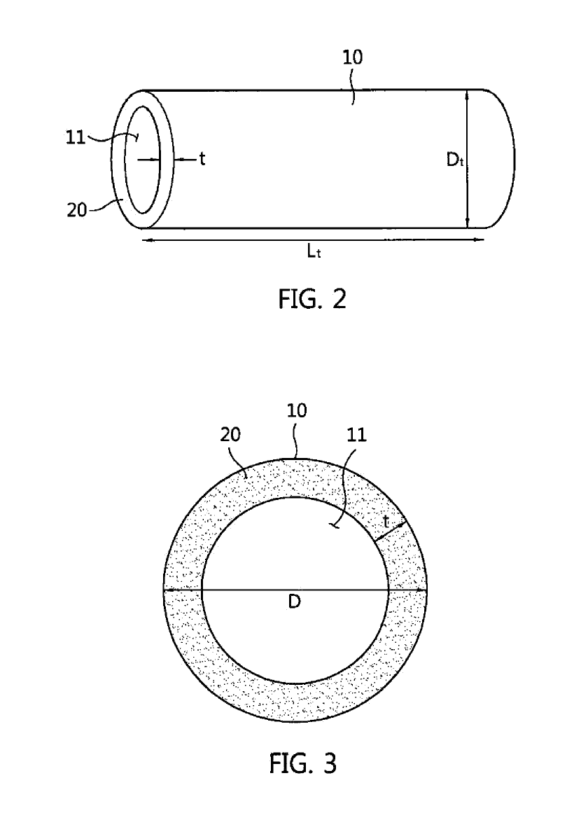

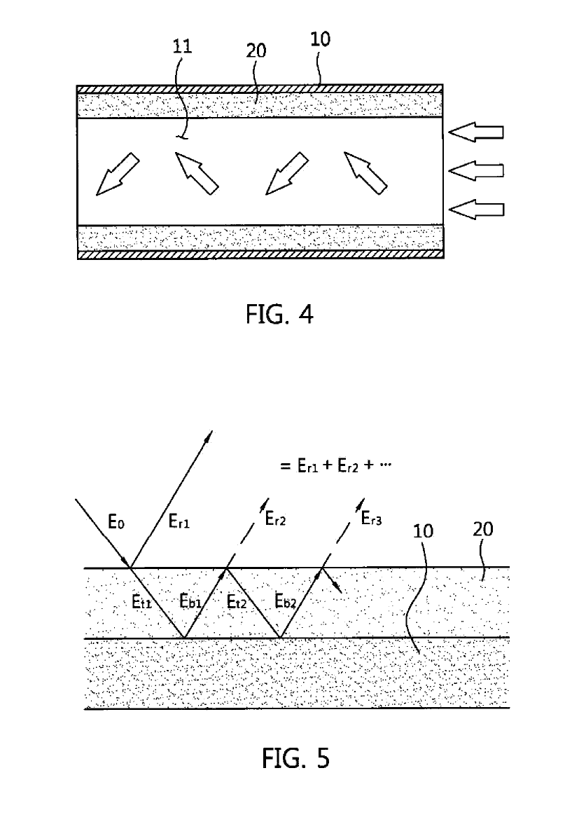

FIG. 2 is a perspective view illustrating a waveguide feedthrough according to an embodiment of the present invention. FIG. 3 is a sectional view taken along line A-A of FIG. 2. FIG. 4 is a sectional view taken along line B-B of FIG. 2. FIG. 5 is a view illustrating an electromagnetic wave absorber 20 for electromagnetic wave attenuation according to the present invention.

The waveguide feedthrough for broadband electromagnetic wave attenuation according to the present invention will be described in detail with reference to FIGS. 2 through 5. The waveguide feedthrough includes a waveguide feedthrough body 10 which is made of conductive material and has a through hole 11, and an electromagnetic wave absorber 20 which is provided on an inner side surface of the through hole 11.

The waveguide feedthrough body 10 is coupled at a first end thereof to a surface of an electromagnetic wave shielding structure and functions as a channel in such a way that a plurality of optical cables enter the electromagnetic wave shielding structure through the through hole 11.

The electromagnetic wave absorber 20 is provided on the inner side surface of the through hole 11 so as to attenuate external electromagnetic waves that enter the electromagnetic wave shielding structure.

That is, if external electromagnetic waves enter the through hole 11 of the waveguide feedthrough body 10, the electromagnetic waves are continuously reflected on the inner side surface of the through hole 11 by the electromagnetic wave absorber 20 provided in the inner side surface of the through hole 11, whereby the magnitude of the electromagnetic waves is gradually reduced.

Furthermore, the electromagnetic wave absorber 20 converts some of the electromagnetic waves that enter the through hole 11 into heat, thus further reducing the magnitude of electromagnetic waves that are reflected on or penetrated into the electromagnetic wave absorber 20. Made of conductive material, the waveguide feedthrough body 10 reflects most electromagnetic waves, but in the case where the electromagnetic wave absorber 20 is provided on the inner side surface of the through hole 11 of the waveguide feedthrough body 10, the reflection rate is reduced.

As shown in the structure of the waveguide feedthrough, if an electromagnetic wave absorber is provided on an inner surface of a body in which electromagnetic waves are moved forwards by multiple reflections, while electromagnetic waves that enter one end of the waveguide feedthrough move to the other end thereof, the magnitude of electromagnetic waves is continuously reduced by multiple reflections. Therefore, the magnitude of electromagnetic waves that are transmitted to the other end of the waveguide feedthrough can be attenuated to a predetermined level.

For instance, in the case of an electromagnetic wave shielding structure which must block electromagnetic waves having frequencies ranging from 0 GHz to 18 GHz, the diameter of the through hole of the conventional waveguide feedthrough is limited to 9 mm or less so as to maintain the electromagnetic wave attenuation capacity at a predetermined level. However, in the waveguide feedthrough according to the present invention, under conditions in which an electromagnetic wave attenuation capacity is 80 dB and the inner diameter of the waveguide feedthrough is 40 mm, the diameter D of the through 11, other than the thickness of the electromagnetic wave absorber, which can be used for installation of optical cables, is 28 mm or more. In other words, the present invention can be manufactured such that the diameter D of the through hole 11 is about three times larger than that of the conventional technique. Depending on the attenuation constant and the thickness t of the electromagnetic wave absorber 20, the electromagnetic wave attenuation capacity may vary.

The waveguide feedthrough body 10 has a cylindrical pipe shape. Having a sheet shape, the electromagnetic wave absorber 20 is attached to the inner side surface of the through hole 11 of the waveguide feedthrough body 10.

f_{c0}=175.8/α [Equation 1]

In Equation 1, α denotes a diameter D (mm) of the waveguide feedthrough body 10, and f_{c0} denotes a cut-off frequency (GHz).

For example, when the cut-off frequencies are 1 GHz, 10 GHz and 18 GHz, the diameters D of the waveguide feedthrough body 10 respectively are 175.8 mm, 17.58 mm and 9.77 mm. Therefore, the diameter D of the waveguide feedthrough body 10 that is used within a frequency range of 10 GHz or more is reduced to 10 mm or less. Furthermore, from a simulation result, in the conventional waveguide feedthrough structure, the diameter D of the waveguide feedthrough body 10 that is required to ensure the effect of shielding electromagnetic waves of 80 dB or more was 11.9 mm when the cut-off frequency was 10 GHz, and it was 9 mm when was 18 GHz.

Thus, in the conventional technique, a plurality of waveguide feedthroughs, each of which has a comparatively small diameter, were required to use a large number of optical cables.

On the other hand, in the present invention, the electromagnetic wave absorber 20 is provided in the waveguide feedthrough body 10, and electromagnetic waves go through the through hole 11 in such a way that, as shown in FIG. 4, they are successively reflected by the electromagnetic wave absorber 20. The rate at which the magnitude of electromagnetic waves is attenuated while being successively reflected depends on the following equation 2.

Γ=Eᵣ/E₀=(Σ^{∞}ₙ₌₁₎Eᵣₙ)/E₀ [Equation 2]

In Equation 2, E₀ denotes the magnitude of an electromagnetic wave that enters the waveguide feedthrough body 10 provided with the electromagnetic wave absorber 20. Eᵣ denotes a reflected wave. The reflected wave is expressed by the sum of multiple reflections which occurs on a boundary surface between the waveguide feedthrough body 10 and the electromagnetic wave, absorber 20.

Penetrated waves Eᵣ₁, Eᵣ₂ that have penetrated the electromagnetic wave absorber 20 go through the electromagnetic wave absorber 20 by multiple reflections on the boundary surface between the waveguide feedthrough body 10 and the electromagnetic wave absorber 20 and are attenuated in a form of an exponential function by an attenuation constant of the electromagnetic wave absorber 20.

The damping constant of the electromagnetic wave absorber 20 is determined by the specific relative permittivity and permeability of the electromagnetic wave absorber 20.

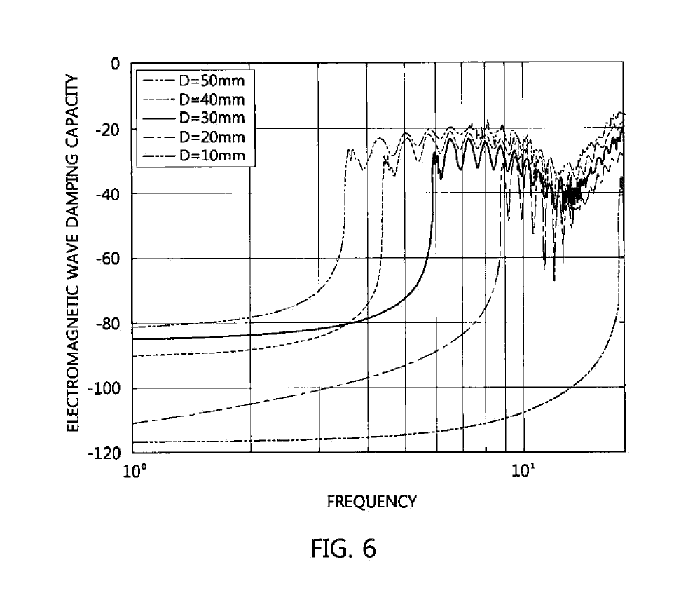

FIG. 6 is a graph showing an electromagnetic wave attenuation capacity as a function of the diameter D of a waveguide feedthrough provided without the electromagnetic wave absorber 20. FIG. 6 shows the electromagnetic wave attenuation capacities of the waveguide feedthroughs 10 that have the same length of 400 mm but have different diameters D from 10 mm to 50 mm with increments increased by 10 mm.

Referring to FIG. 6, it can be understood that, as the diameter D of the waveguide feedthrough is reduced, the cut-off frequency is increased, and when the frequency is constant, the smaller the diameter of the waveguide feedthrough, the greater the electromagnetic wave attenuation capacity thereof.

For instance, under conditions in which the electromagnetic wave attenuation capacity is 60 dB or more, when the diameter D of the waveguide feedthrough is 50 mm, the frequency is 3.4 GHz, but when the diameter D is 10 mm, the frequency is 17.48 GHz. Therefore, as the frequency increases, the diameter D of the waveguide feedthrough must be reduced. Furthermore, to block a comparatively high frequency of 18 GHz, the diameter of D of the conventional waveguide feedthrough must be designed to be 10 mm or less.

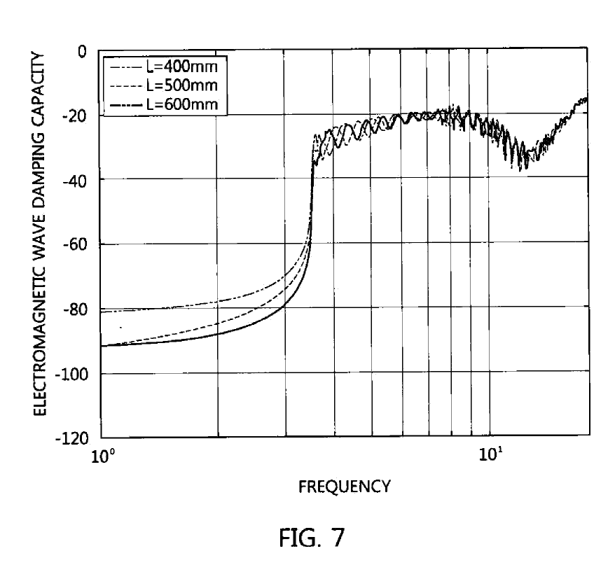

FIG. 7 is a graph showing an electromagnetic wave attenuation capacity as a function of the length L of a waveguide feedthrough provided without the electromagnetic wave absorber 20. FIG. 7 shows the electromagnetic wave attenuation capacities when the lengths L are 400 mm, 500 mm and 600 mm under conditions in which the diameter D of the waveguide feedthrough is 50 mm.

Referring to FIG. 7, it can be appreciated that even when the length L of the waveguide feedthrough is increased from 400 mm to 600 mm, the cut-off frequency which depends on the diameter D is almost constant.

For example, under conditions in which the frequency is 3 GHz, the electromagnetic wave attenuation capacity ranges from 69 dB to 79 dB, that is, does not largely change.

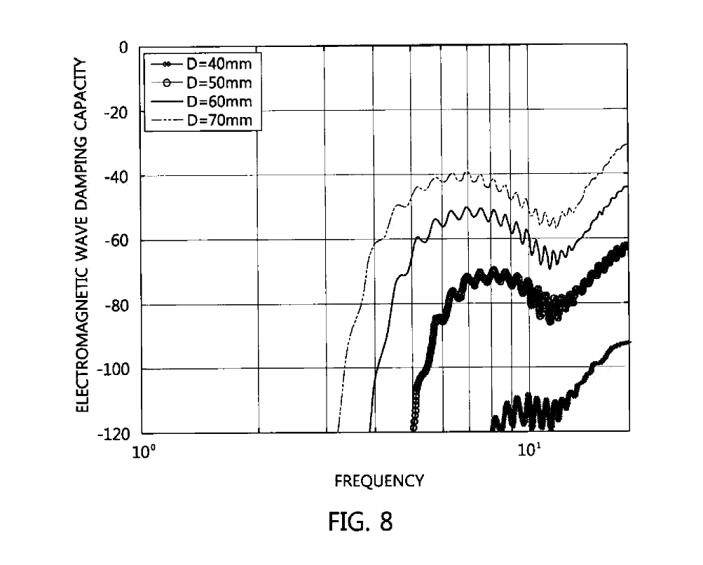

FIG. 8 is a graph showing an electromagnetic wave attenuation capacity as a function of the diameter D of the waveguide feedthrough provided with the electromagnetic wave absorber 20. FIG. 8 shows electromagnetic wave attenuation capacities of the waveguide feedthroughs 10 that have the same length of 400 mm but have different diameters D from 40 mm to 70 mm with increments increased by 10 mm.

Referring to FIG. 8, it can be understood that, as the diameter D of the waveguide feedthrough is reduced, the cut-off frequency is increased. However, in this case, when the diameter D is 40 mm, the electromagnetic wave attenuation capacity is 80 dB or more even at a frequency of 18 GHz. That is, it can be understood that the electromagnetic wave attenuation capacity becomes superior, compared to the case of FIG. 6 where the length is 400 mm and the diameter D is 40 mm.

As stated above, the electromagnetic wave attenuation capacity of the waveguide feedthrough according to the present invention depends on the diameter D of the waveguide feedthrough body 10, that is, the diameter of the through hole 11, the length L of the waveguide feedthrough body 10 and the attenuation constant and the thickness t of the electromagnetic wave absorber 20.

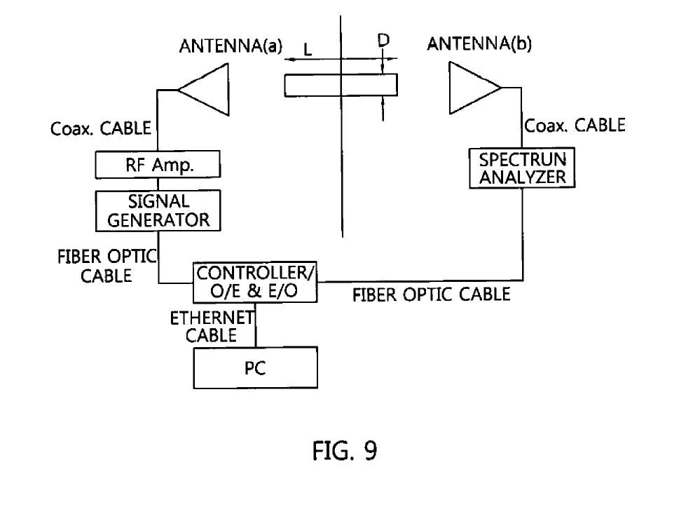

FIG. 9 is a block diagram showing the construction of a test for measuring the electromagnetic wave attenuation capacity of the waveguide feedthrough according to the present invention. In this test, antennas were respectively installed inside and outside the electromagnetic wave shielding structure, and the waveguide feedthrough according to the present invention was disposed therebetween. In this state, the magnitude of electromagnetic waves that are transmitted through the waveguide feedthrough was measured.

Resulting from the construction of the test of FIG. 9, the electromagnetic wave attenuation capacity can be calculated from the following equation 3.

SE=20log₁₀(E₂/E₁)=10log₁₀(P₂/P₁) [Equation 3]

Here, E₁ and P₁ respectively denote an electric field and power which are measured without the electromagnetic wave absorber 20 according to the present invention. E₂ and P₂ respectively denote an electric field and power which are measured in the case where the electromagnetic wave absorber 20 according to the present invention is provided.

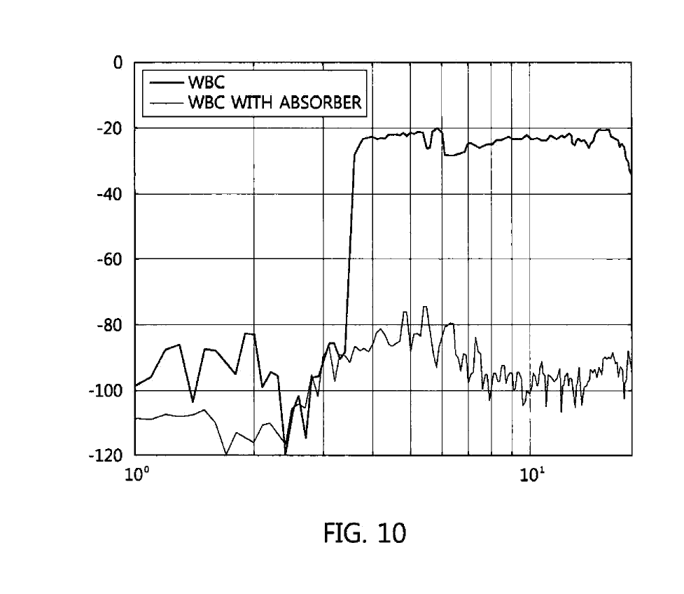

FIG. 10 shows an example of the result of the test of FIG. 9 according to Equation 3 and is a graph comparing the electromagnetic wave attenuation capacity of the waveguide feedthrough provided with the electromagnetic wave absorber 20 according to the present invention with that of the waveguide feedthrough provided without the electromagnetic wave absorber 20.

In detail, FIG. 10 compares the electromagnetic wave attenuation capacity measured in the case where the diameter D of the waveguide feedthrough is 50 mm, the length L thereof 500 mm, and the thickness t of the electromagnetic wave absorber 20 attached to the inner side surface of the through hole 11 is 6 mm with the electromagnetic wave attenuation capacity of the waveguide feedthrough that, has the same diameter D and length L but is provided without the electromagnetic wave absorber 20.

Referring to FIG. 10, when measured the electromagnetic wave attenuation capacity of the waveguide feedthrough (WBC) provided without the electromagnetic wave absorber 20, in a frequency range of 3.5 GHz or more, the magnitude of electromagnetic waves was attenuated only by about 20 dB similar to the simulation result. On the other hand, in the case of the waveguide feedthrough provided with the electromagnetic wave absorber 20 attached to the inner side surface of the through hole 11 (WBC with absorber), the magnitude of electromagnetic waves was attenuated by 80 dB or more at most area of the frequency range to 18 GHz.

As described above, in the case where the electromagnetic wave absorber 20 is provided on the inner side surface of the through hole 11 of the waveguide feedthrough, even when the waveguide feedthrough has a comparatively low cut-off frequency (a large diameter), an improved electromagnetic wave shielding effect can be obtained even in a high-frequency range.

Therefore, because the waveguide feedthrough according to the present invention which is manufactured in a form of a single cylinder is able to have a comparatively large diameter, it becomes easy to install a plurality of optical cables. As a result, material and processing costs required to manufacture the waveguide feedthrough can be markedly reduced compared to those of the conventional technique.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A waveguide feedthrough for broadband electromagnetic wave attenuation, comprising:
a waveguide feedthrough body made of conductive material, with a through hole formed in the waveguide feedthrough body; and
an electromagnetic wave absorber provided on an inner side surface of the through hole.

2. The waveguide feedthrough as set forth in claim 1, wherein the waveguide feedthrough body has a cylindrical pipe shape.

3. The waveguide feedthrough as set forth in claim 1, wherein the electromagnetic wave absorber has a sheet shape and is attached to the inner side surface of the through hole.

4. The waveguide feedthrough as set forth in claim 2, being installed in an electromagnetic wave shielding structure, wherein a plurality of optical cables are led out of the electromagnetic wave shielding structure through the waveguide feedthrough.
